(19) United States
(12) Patent Application Publication
(10) Pub. No.: US 2020/0192138 A1
(43) Pub. Date: Jun. 18, 2020

(54) FLAT SCREEN HAVING A CONTINUOUS DISPLAY AREA AND COMPRISING TWO CONTIGUOUS LIQUID-CRYSTAL CELLS

(71) Applicant: THALES, Courbevoie (FR)

(72) Inventors: Philippe CONI, SAINT JEAN D'ILLAC (FR); Hugues LEBRUN, COUBLEVIE (FR); Philippe CHABOT, ST AUBIN DE MEDOC (FR)

(21) Appl. No.: 16/702,445

(22) Filed: Dec. 3, 2019

(30) Foreign Application Priority Data
Dec. 18, 2018 (FR) 1872953

(51) Int. Cl. G02F 1/1333; G02F 1/1339; G02F 1/1335

(52) U.S. Cl. CPC G02F 1/13336; G02F 1/13394; G02F 2001/13396; G02F 1/13338; G02F 1/133528

(57) ABSTRACT

A display screens includes at least two liquid-crystal cells, the first cell having a first active area and a first transparent sealing region and the second cell having a second active area and a second transparent sealing region. The screen comprises: in a first plane, the first cell and a first transparent sheet of same thickness, the first sealing region being located between the two; in a second plane parallel to the first plane, the second cell and a second transparent sheet of same thickness, the second sealing region being located between the two; the second cell being placed under the first sheet, the second sheet being placed under the first cell so that the first active area is in the exact extension of the second active area.

### CROSS-REFERENCE TO RELATED APPLICATIONS

This application claims priority to foreign French patent application No. FR 1872953, filed on Dec. 18, 2018, the disclosure of which is incorporated by reference in its entirety.

### FIELD OF THE INVENTION

The field of the invention is that of flat-screen systems requiring a large display area obtained by means of a plurality of individual screens. The preferred but nonlimiting field of application of the invention is that of aircraft cockpit displays.

### BACKGROUND

In a certain number of applications, it is necessary to provide large display areas in order to present information that is indispensable to the management and operation of a complex system. This is in particular the case in aircraft cockpits in which display screens present information relating to piloting, navigation and control of the various on-board systems.

Currently, in the aeronautical field, medium-size screens are used, so as to group together information and to decrease the number of instruments. However, the decrease in the number of screens must not lead to device availability problems in case of a single malfunction which may lead to the simultaneous loss of a number of functions previously distributed over a number of screens.

It is not possible to meet regulatory requirements with respect to flight safety using screens of the same nature, as there is a risk of common malfunction as a result of a fault possibly due to the design or the manufacture of a defective component.

Aircraft cockpits comprise a so-called “back-up” secondary instrument that has the particularity of being different from the primary display means, in order to prevent a generic malfunction from leading to complete loss of the display of information to the pilots. This instrument is generally smaller and offers fewer functions than the primary system. It places additional workload on the pilots when its use becomes necessary, on account of its small display area.

To increase the display area, it is possible to place side-by-side two display screens so as to obtain a larger area. It is then necessary for the two screens to be physically segregated in order to prevent common malfunction problems. The only common parts are then structural parts and the protective window of the screens, these common points being considered to be acceptable.

This solution has the advantage of achieving large display areas using elementary display modules. Thus, FIG. 1 shows an image-displaying system comprising two large flat screens 1 and 2 place side-by-side. These screens are, for example, liquid-crystal screens. A large image such as, for example, a cartographic representation, may be continuously displayed on the two screens. The drawback of the system, as may be seen in FIG. 1, is that, for mechanical and electronic reasons, the display region of each screen (which region is shown in white in FIG. 1) does not cover all the area of the screen. Thus, the display system comprises inactive borders 3 and 4 between the screens that form a bar in the central portion of the displayed image. These borders 3 and 4 are shown hatched in FIG. 1. The human eye is very sensitive to this effect. Thus, not only does a border that is only one millimetre wide remain perfectly visible, but also the loss of a single column of the width of a pixel of an active matrix still remains visible.

A plurality of technical solutions for correcting this problem have been proposed.

A first solution (shown in FIG. 2) is described in the publication entitled “Printed cylindrical lens pair for application to the seam concealment in tiled displays” of Department of Electrical and Computing Engineering, Seoul National University, published in the journal Optics Express on 22 Jan. 2018. It consists in placing, on the screens 1 and 2 in the region common with the adjacent screen, optical sheets 5 and 6 the curved edges of which form an image of the viewing area of larger size, thus masking the edges of the screen, which are shown hatched in FIG. 2. In this figure and in FIG. 3, the liquid-crystal matrices are symbolized by helices of molecules and the light rays output from the screens by arrows. This solution allows the absence of image between the two screens to be almost completely concealed when the image is regarded on-axis.

It will however be understood that this local magnification effect will not produce a perfect image. In particular, once the field angle increases, the region of separation between the two screens becomes visible again. Moreover, the optical component adds an extra thickness. This extra thickness has two drawbacks. It causes parallax and makes touch interactions impossible in the region of the optical sheet.

One variant of this solution is described in patent U.S. Pat. No. 6,927,908, which is entitled “Visual display screen arrangement”. It has more or less the same drawbacks.

A second solution would be to use flat screens with curved edges, such as employed in certain smart phones. This type of screen necessarily deforms the images in the curved regions thereof.

The display system according to the invention does not have the preceding drawbacks.

In the rest of the description, the following definitions are used: a liquid-crystal cell is the glass cell containing the liquid crystal without polarizers, and the liquid-crystal screen is the preceding cell placed between crossed polarizers.

The liquid-crystal cells have an active area composed of active pixels and a sealing region that comprises no active pixels. However, this region has the advantage of being relatively transparent. When it is placed between two crossed polarizers, as it is neutral with respect to the polarization of the light, it appears black, contrary to the liquid crystal which polarizes the light.

Thus, if two liquid-crystal cells are placed in different planes so that their respective sealing regions overlap exactly, it is possible to illuminate the above cell through the sealing region of the below cell and it is possible to see the below cell through the sealing region of the above cell. By placing a polarizing film common to the two cells on either side of said cells, an almost perfect continuity between the two images displayed by each of the active areas is ensured. In so far as the two cells have small thicknesses, the differences in height between the two cells may, moreover, be compensated for by transparent sheets, so as to create, on each face, a plane of uniform altitude, facilitating lamination of the polarizing films common to the two cells.

### SUMMARY OF THE INVENTION

More precisely, one subject of the invention is a fault-tolerant display screen comprising at least two liquid-crystal cells equipped with two common polarizers, the first cell having a first active area and a first transparent sealing region located on a first side of said first active area and the second cell having a second active area and a second transparent sealing region located on a second side of said second active area, characterized in that the system comprises:
in a first plane, the first cell and a first transparent sheet of same thickness as that of the first cell, the first sealing region being located between the first active area and the first transparent sheet, a first polarizer being laminated to a face common to the first cell and to the first transparent sheet;
in a second plane parallel to the first plane, the second cell and a second transparent sheet of same thickness as that of the second cell, the second sealing region being located between the second active area and the second transparent sheet, the second polarizer being laminated to a face common to the second cell and to the second sheet,
the second cell being placed under the first transparent sheet, the second transparent sheet being placed under the first cell so that the second sealing region is located under the first active area and the first sealing region is located on the second active area, the first active area being in the exact extension of the second active area, each sealing region thus being located superposed with an active-area region, thus ensuring the continuity of the display screen.

Advantageously, the two sealing regions exclusively comprise spacers taking the form of columns, the position of said spacers being set, for the first sealing region, depending on the location of the opaque regions of the portion of the second active area of the screen located under this first region, and for the second sealing region, depending on the location of the opaque regions of the portion of the first active area of the screen located above this second region.

Advantageously, the spacers of the sealing regions have heights identical to those of the spacers of the first active area or of the second active area.

Advantageously, the spacers of the sealing regions have heights different from those of the spacers of the first active area or of the second active area.

Advantageously, the regions located under the first sealing region and under the second sealing region are illuminated by a lighting device so as to compensate for absorption and scattering of light by the first sealing region and by the second sealing region.

The invention also relates to a display system comprising a display screen such as defined above and a graphics processor that addresses the second active area, the graphics displayed in the region of the second active area located under the first sealing region having a different resolution to that of the graphics displayed on the rest of the second active area, said resolution being tailored to how much this first sealing region scatters light.

In one variant embodiment, the graphics processor comprises a smoothing function applied to the graphics displayed in the region of the second active area located under the first sealing region, said smoothing function being tailored to how much this first sealing region scatters light.

Advantageously, the display screen of the display system comprises a touch surface placed on the first polarizer.

### BRIEF DESCRIPTION OF THE DRAWINGS

The invention will be better understood and other advantages will become apparent on reading the following description, which is given nonlimitingly, and by virtue of the appended figures, in which:

FIG. 1 shows a system comprising two flat screens according to the prior art;

FIG. 2 shows a system comprising two flat screens according to the prior art comprising an optical device allowing the dead region between two adjacent screens to be decreased;

FIG. 3 is a partial cross-sectional view of a display screen comprising two liquid-crystal cells according to the invention;

FIG. 4 is a front view of a display screen comprising two liquid-crystal cells according to invention;

FIG. 5 is a partial cross-sectional view of the display screen according to the invention comprising tailored lighting.

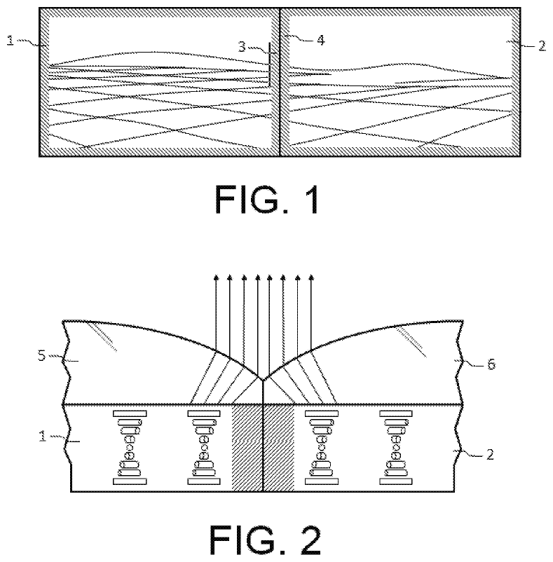

### DETAILED DESCRIPTION

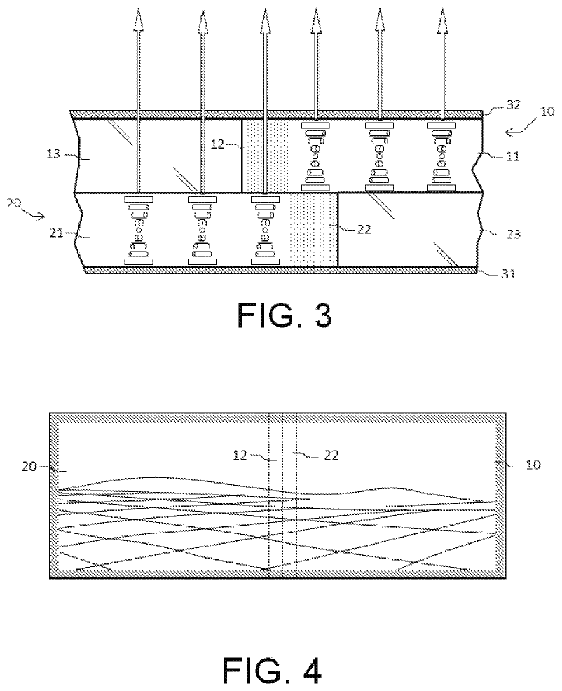

By way of nonlimiting example, FIG. 3 shows a cross-sectional view of a display screen according to invention comprising two contiguous cells. FIG. 3 only shows the two cells in the region of the junction.

It will be noted that the principle of the invention may be applied to a higher number of screens. The final architecture is however limited by the circuits for controlling the lines located on the side opposite the sealing region.

The display screen essentially comprises: a first rectangular matrix liquid-crystal cell 10. This first cell has a first active area 11 and a first transparent sealing region 12 located on a first side of this first active area;
a second rectangular matrix liquid-crystal cell 20. This second cell has a second active area 21 and a second transparent sealing region 22 located on a second side of this second active area;
a first transparent planar glass sheet 13 of same thickness as the first cell; a second transparent planar glass sheet 23 of same thickness as the second cell; a first polarizer 31 and a second polarizer 32.

The invention works with any type of liquid-crystal cell. By way of nonlimiting example, the cells may be of the following types:
twisted nematic (TN);
in-plane switching (IPS)
vertical alignment (VA);
polymer-stabilized vertical alignment (PSVA);
active frequency selective surface (AFSS).

The first cell 10 and the first transparent sheet 13 are placed in a first common plane, the first sealing region 12 being located between the first active area 11 and the first transparent sheet 13.

The second cell 20 and the second transparent sheet 23 are placed in a second common plane parallel to the first plane, the second sealing region 22 being located between the second active area 21 and the second transparent sheet 23.

The second cell 20 is adhesively bonded under the first transparent sheet 13, the second transparent sheet 23 being adhesively bonded under the first screen cell 10 so that the second sealing region 22 is located under the first active area 11 and so that the first sealing region 12 is located above the second active area 21 and so that the first active area 11 is in the exact extension of the second active area 21, such as shown in FIG. 3. These various assembling operations will present no particular technical difficulty to a person skilled in the art.

The assembly consisting of the first cell, the first transparent sheet, the second cell and the second transparent sheet is placed between the two polarizers 31 and 32. In addition, the display screen comprises a lighting device placed under the second cell and under the second transparent sheet and the polarizer 31. This lighting device is not shown in FIG. 3. The assembly equipped with its lighting device forms a fault-tolerant display screen.

It is also possible to deposit a touch panel either on one of the cells, or on all of the area of the display screen. It is also possible to place an antireflection glass layer on this assembly above the polarizer 32.

With this arrangement, the image generated by the portion of the second active region located under the first sealing region may be seen since this region is transparent. The polarized light generated by the lighting device in the region located under the second sealing region may pass without difficulty through this region in order to light the portion of the first active region located above the second sealing region. Thus, the perceived image appears to be without discontinuity, as may be seen in FIG. 4, which shows a front view of the preceding display system comprising the two liquid-crystal cells 10 and 20 according to the invention.

The two active surfaces are located, by construction, in different planes. However, the height difference is necessarily small in so far as the cells are thin and, moreover, is to a large extent compensated for optically by the transparent sheets.

The two sealing regions 12 and 22 must be as transparent as possible so as not to distort the images generated by the active areas in these regions.

To decrease the optical distortions due to a failing in the optical transmission of the sealing regions, it is important to remove these regions or to mask, in these regions, any object liable to contribute to the scattering of light such as the “spacers” when they are randomly mixed in the adhesive of the sealing bead in the form of rods or beads. The role of the spacers is to define the thickness of the sealing region. They generally take the form of beads or rods and are distributed in the sealing bead. It is preferable to replace them with spacers taking the form of columns the position of which is predefined, for example, by lithography or screen-printing on one of the two glass plates bearing either the active matrix or the colour filters and forming the liquid-crystal cell. These spacers, the position of which is then chosen, may be masked by a metal layer of the colour-filter plate of the active matrix and therefore invisible to the user and not contribute to the scattering of light.

These spacers may have a height different from those of the active region in order to compensate for the absence of colour filters in the sealing regions. It is also possible to use spacers of the same size as those of the active matrix if a colour layer is placed in the sealing region.

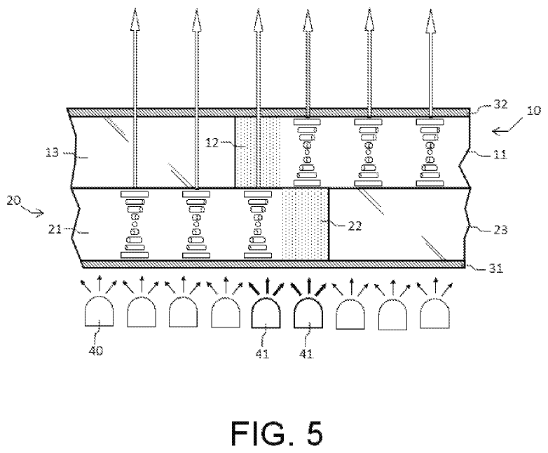

Despite these precautions, a difference in transmission in the sealing regions may remain visible. It is possible to compensate therefor by adjusting either the gradient of the backlighting device, or the modulation of the active matrix, or by adjusting both thereof. By way of example, FIG. 5 shows a lighting system 40 based on light-emitting diodes, in which the diodes 41 placed under the sealing regions emit more light.

The sealing regions may also scatter slightly. The scattering nature of the seal may thus degrade spatial resolution. Thus, it is preferable to avoid displaying small characters or fine lines in these regions by adopting a different resolution in these regions. The graphics processor that addresses the liquid-crystal cells may advantageously comprise a different blur-mask smoothing filter in these regions, in order to prevent this effect from becoming too visible.

The sealing adhesive chosen scatters as little as possible, is achromatic and has the best possible transmittance between parallel polarizers.

The two cells are advantageously electrically independent and may be supplied by two different manufacturers that do not use the same components, nor the same manufacturing processes and means. It will be noted that it is not even necessary for the two cells to have the same thickness. It is thus easy to demonstrate that a malfunction affecting one of the cells cannot have any effect on the second cell. This is a considerable advantage. This architecture makes it highly unlikely that the entirety of the display screen will be lost in case of a single malfunction or of a generic malfunction corresponding to a common fault leading to simultaneous loss of devices of the same composition. In this respect, it is a fault-tolerant display system.

The availability of information of primary importance to the flight after a single malfunction and/or a generic malfunction of one of the two screens is therefore ensured, at least by the remaining functional screen, a simultaneous malfunction of both screens being highly unlikely.

Thus, the objectives with respect to flight security specific to aeronautics are met while guaranteeing a large display area.

1. A fault-tolerant display screen comprising at least two liquid-crystal cells equipped with two common polarizers, the first cell having a first active area and a first transparent sealing region located on a first side of said first active area and the second cell having a second active area and a second transparent sealing region located on a second side of said second active area, wherein the system comprises:
in a first plane, the first cell and a first transparent sheet of same thickness as that of the first cell, the first sealing region being located between the first active area and the first transparent sheet, a first polarizer being laminated to a face common to the first cell and to the first transparent sheet;
in a second plane parallel to the first plane, the second cell and a second transparent sheet of same thickness as that of the second cell, the second sealing region being located between the second active area and the second transparent sheet, the second polarizer being laminated to a face common to the second cell and to the second sheet,
the second cell being placed under the first transparent sheet, the second transparent sheet being placed under the first cell so that the second sealing region is located under the first active area and the first sealing region is located on the second active area, the first active area being in the exact extension of the second active area, each sealing region thus being located superposed with an active-area region, thus ensuring the continuity of the display screen.

2. The display screen according to claim 1, wherein the two sealing regions exclusively comprise spacers taking the form of columns, the position of said spacers being set,
for the first sealing region, depending on the location of the opaque regions of the portion of the second active area of the cell located under this first region, and
for the second sealing region, depending on the location of the opaque regions of the portion of the first active area of the cell located above this second region.

3. The display screen according to claim 2, wherein the spacers of the sealing regions have heights identical to those of the spacers of the first active area or of the second active area.

4. The display screen according to claim 2, wherein the spacers of the sealing regions have heights different from those of the spacers of the first active area or of the second active area.

5. The display screen according to claim 1, wherein the regions located under the first sealing region and under the second sealing region are illuminated by a lighting device so as to compensate for absorption and scattering of light by the first sealing region and by the second sealing region.

6. The display system comprising a display screen according to claim 1, wherein the display system comprises at least one graphics processor that addresses the second active area, the graphics displayed in the region of the second active area located under the first sealing region having a different resolution to that of the graphics displayed on the rest of the second active area, said resolution being tailored to how much this first sealing region scatters light.

7. The display system comprising a display screen according to claim 1, wherein the display system comprises at least one graphics processor that addresses the second active area, the graphics processor comprising a smoothing function applied to the graphics displayed in the region of the second active area located under the first sealing region, said smoothing function being tailored to how much this first sealing region scatters light.

8. The display system according to claim 6, wherein the display screen comprises a touch surface placed on the first polarizer.
